(19) United States
(12) Patent Application Publication
(10) Pub. No.: US 2017/0194897 A1
(43) Pub. Date: Jul. 6, 2017

(54) SOILING STATION APPARATUS, METHODS, AND SYSTEMS USEFUL FOR MONITORING AND MAINTAINING PHOTOVOLTAIC MODULES

(71) Applicant: Nor-Cal Controls ES, Inc., Diamond Springs, CA (US)

(72) Inventors: Bob LOPEZ, Pollock Pines, CA (US); Rob LOPEZ, El Dorado Hills, CA (US); Troy MORLAN, Pine Grove, CA (US); Dustin DEQUINE, Fair Oaks, CA (US); Stacy NALEPA, Cool, CA (US)

(21) Appl. No.: 14/989,465

(22) Filed: Jan. 6, 2016

(51) Int. Cl. H02S 40/10; H02S 50/00

(52) U.S. Cl. CPC H02S 40/10; H02S 50/00

(57) ABSTRACT

A soiling station for photovoltaic maintenance and monitoring includes a cover movable from a first position to a second position; and a photovoltaic module. The cover is configured and arranged to cover the photovoltaic module when the door is in the first position, and wherein a sensor is configured to detect a solar irradiance of the photovoltaic module.

### FIELD

The disclosure relates to photovoltaic (PV) energy systems. In particular, the disclosure relates soiling station apparatus, methods, and systems useful for monitoring and maintaining PV module operability, and enhancing an amount and consistency of power output.

### BACKGROUND

A range of factors have been found to affect efficiency of energy capture and output of PV modules. It has been recognized that soiling accumulation on PV modules results in energy loss and revenue loss. Soiling is defined as including, inter alia, deposition of dust, dirt, mud, avian waste products, and hard water stains each accumulate, alone or in combination, on a PV module, or solar sensor. The amount and type of soiling that can occur on a PV module depends on, for example, a geographical location of the PV module. Geographical locations with high wind typically associate with a higher probability of reduced energy yield than locations with little to no wind. Conversely, higher annual rainfall has been found to aid in cleaning PV modules, thereby reducing revenue losses due to energy yield lowered by soiling. A solar plant having multiple PV modules or PV module arrays may affect soiling amounts through configuration of PV modules. Differences in soiling amounts have been observed and found to be due to angle of incidence with respect to fixed versus tracking systems.

Soiling stations have been developed to address soiling of PV modules. Typical soiling stations use a control module, a clean module, and a test module. The test module is exposed to the same influences and conditions as PV modules of a PV module array in a PV system, for example. The test module surface area is typically configured to match a size of the surface area of an array PV module. Such soiling stations use an aqueous wash to clean the control module, for which a constant supply of cleaning solution is required.

### SUMMARY

A need exists for soiling station apparatus, methods, and systems useful for monitoring and maintaining PV module operability, and enhancing amount and consistency of power output. Accordingly, soiling station apparatus, methods, and systems useful for monitoring and maintaining PV module operability and enhancing amount and consistency of power output are provided that have a smaller footprint, lower equipment, installation, and maintenance costs, and that allow for mounting in a variety of configurations for enhanced reading accuracy and usefulness. Soiling station apparatus, methods, and systems in accordance with embodiments provide accurate, cost-effective data that utility-scale independent system operators (ISO) rely on efficiently-run and maintained PV modules and PV systems. Apparatus, methods, and systems of embodiments enable automated maintenance scheduling, reduced man-hour requirements for installation, operation, and maintenance, increased efficiencies and profits over typical soiling stations, decreased solar absorption losses, and operability with any supervisory control and data acquisition (SCADA) platform.

Apparatus in accordance with one embodiment include a cover, the cover movable from a first position to a second position; and a photovoltaic module, wherein the cover is configured and arranged to cover the photovoltaic module when the door is in the first position. The sensor is configured to detect a solar irradiance of the photovoltaic module. In an embodiment, the photovoltaic module is a first photovoltaic module, and the apparatus may include a second photovoltaic module, wherein the cover is configured to cover only the first photovoltaic module.

In another embodiment, the sensor is a first sensor, and the apparatus may include a second sensor configured to detect a cover position of the cover. In an embodiment, the processing may include comparing sensor data feedback from the first sensor with sensor data feedback from the second sensor for determining a soiling of the second photovoltaic module.

In yet another embodiment, apparatus may include an enclosure containing or supporting the first sensor, the second sensor, the first photovoltaic module, the second photovoltaic module, and the cover; and a third sensor configured to detect a temperature of a first portion of the enclosure. In another embodiment, apparatus may include a fourth sensor configured to detect a temperature of a second portion of the enclosure. The apparatus may include a fifth sensor configured to detect solar irradiance, the fifth sensor configured and arranged to detect a solar irradiance of the second photovoltaic module. The apparatus may include one or more controllers for processing sensor data, the sensor data comprising data based on sensor feedback from at least one of the first sensor, the second sensor, the third sensor, the fourth sensor, and the fifth sensor.

In an embodiment, a surface area of the first photovoltaic module is substantially equal to a surface area of the second photovoltaic module. In another embodiment, a surface area of the first photovoltaic module is less than a surface area of the second photovoltaic module.

In an embodiment, apparatus may include a motor configured to cause the cover to move between a first position and a second position. The cover is configured to form a sealed space surround the first photovoltaic module when the cover is disposed in the first position. In embodiment, the apparatus may include a hinged door. In an embodiment, the apparatus may include an enclosure supporting or containing the sensor, the photovoltaic module, and the cover, wherein the photovoltaic module interposes the enclosure and the cover when the cover is in the first position. The cover may be movable to a plurality of positions between and including the first position and the second position for providing variable coverage for protection of the first module that corresponds with varying levels of exposure to soiling.

In an embodiment, the cover may comprise a rigid material. In another embodiment, the cover may comprise a deformable material.

An embodiment of methods may include determining solar irradiance of a first photovoltaic module; determining solar irradiance of a second photovoltaic module; communicating one or both determinations of solar irradiance; processing the determinations of solar irradiance to compare the determinations to obtain a soiling amount of the second photovoltaic module; and comparing the soiling amount to a predetermined threshold value to determine whether the soiling amount equals or exceeds the threshold amount. In an embodiment, methods may include covering the second photovoltaic module; and opening the cover to expose the photovoltaic module to enable the determination of solar irradiance thereof.

An embodiment of systems may include a first sensor configured for determining solar irradiance of a first photovoltaic module; a second sensor configured for determining solar irradiance of a second photovoltaic module; a communications system configured for communicating one or both determinations of solar irradiance; and one or more processors configured for processing the determinations of solar irradiance to compare the determinations to obtain a soiling amount of the second photovoltaic module, and comparing the soiling amount to a predetermined threshold value to determine whether the soiling amount equals or exceeds the threshold amount.

Additional features and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 shows a side view of a soiling station in accordance with an exemplary embodiment;

FIG. 2 shows a side view of a soiling station in accordance with an exemplary embodiment;

FIG. 3 shows a plan view of a soiling station in accordance with an exemplary embodiment;

FIG. 4 shows a side view of a soiling station in accordance with an exemplary embodiment;

FIG. 5 shows a side view of a soiling station in accordance with an exemplary embodiment;

FIG. 6 shows a method of determining soiling in accordance with an exemplary embodiment;

FIG. 7 shows a cross-sectional view of the apparatus of FIG. 1 along section A-A;

FIG. 8 shows a cross-sectional view of the apparatus of FIG. 1 along section B-B;

FIG. 9 shows processes for PV module monitoring and maintenance in accordance with an exemplary embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about”.

PV system performance is highly dependent on various operating conditions, including availability of solar irradiance to PV module sensor(s). Cleanliness of a PV module is directly correlative to sensor exposure to solar irradiance. Energy capture is an indicator of success of a solar installation or PV system. A substantial investment in time, money, and energy is typically required before installing PV modules; mechanical and analytical tools are used to detect an amount of energy capture and efficacy of installed PV modules. Soiling is accumulation on a module sensor surface of debris such as dust, dirt, snow, avian and mammal feces, insects and insect waste, and other materials that impede light absorption by the module. Soiling can be particularly problematic, or at least more frequently problematic, where rainfall is unavailable to aid in de-soiling sensor surfaces.

The present disclosure addresses and solves problems attendant upon PV module soiling. Apparatus, methods, and systems of embodiments enable PV module and system end users to enhance energy output, efficiency, and profit by indicating when PV module performance is declining due to soiling. Apparatus, methods, and systems of embodiments obviate the need for related art methods for cleaning PV modules by using a cover to protect a sensor of a PV module from exposure to weather and other elements that contribute to soiling.

Apparatus may include an outdoor rated NEMA enclosure. The enclosure may support or contain one or more PV modules including digital silicon irradiance sensors. For example, such sensor may include Si-RS485-TC-T formed of monocrystalline silicon, available from IMT Solar. The enclosure may support a glass protective plate disposed over the one or more sensors, such as glass having high transmittance, low iron content, and being 3/16 of an inch thick, for example. The enclosure may support or contain a controller, memory, and a communications system. For example, the apparatus may include a MODBUS web server, AMJR-14-IP, available from Control Solutions, Inc. Minnesota. The web server may be configured for determining and logging soiling percentage of a first sensor, determining a cover position status of a second sensor, determining an error of a cover operation, and determining when soiling of the first sensor reaches a predetermined threshold indicating a need to clean the first sensor to maintain desire irradiance of the first sensor.

Apparatus may include a cover. The cover may be a hinged or slidable door. The cover may be rigid and formed of glass, metal, composite, or polymer material. The cover may be collapsible and formed of, for example, cloth. The cover may be configured for protecting the second sensor from exposure to weather and other elements that contribute to soiling. The cover may be configured for moving from a first position in which the cover protects the second sensor, to a second position in which the cover is displaced to expose the second sensor for solar absorption. The movement may be motorized and configured for remote control. For example, the enclosure may support or contain a high torque digital gear, such as HS-5645MG, available from Hitec. The gear may be connected to a hinge or sliding mechanism associated with the cover for moving the cover to one or more positions. The apparatus may configured to connect to a power source.

Apparatus may include a single module or two more modules. A size of the two or more modules may be substantially equal in some embodiments. In other embodiments, the size of the first module may be large than the size of the second module, or the size of the second module may be larger than the size of the first module.

Methods may include determining solar irradiance of a first module or sensor. Methods may include determining a temperature of a first portion, such as a bottom, of the first module, and determining a temperature of a second portion, such as a top, of the first module. Methods may include determining solar irradiance of a second module or sensor, or clean module. Methods may include determining a temperature of a first portion, such as a bottom, of the second module, and determining a temperature of a second portion, such as a top, of the second module. The first module is a soiled reference module that remains uncovered and exposed, while the second module is associated with a cover and configured to be covered and protected from the elements by the cover until removed to expose the underlying sensor to determine a solar irradiance thereof.

The measurements taken from the first and second modules may be stored, and may be processed and used to determine a soiling percentage of the first module. A position of the cover of the second module, and any error associated with the cover may be determined and stored. A cleaning indicator may be triggered and presented to a user by any now known or later developed communications means.

Systems may include an apparatus as discussed above, and a communications system. The communications system may be separate from the enclosure and configured to communicate with and receiving communications from the web server contained by the enclosure. The communications system may be connected to the enclosure by a communication cable, and may be located near other SCADA equipment at an installation location. The communications system may be connected to an intranet or internet, or other equipment.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

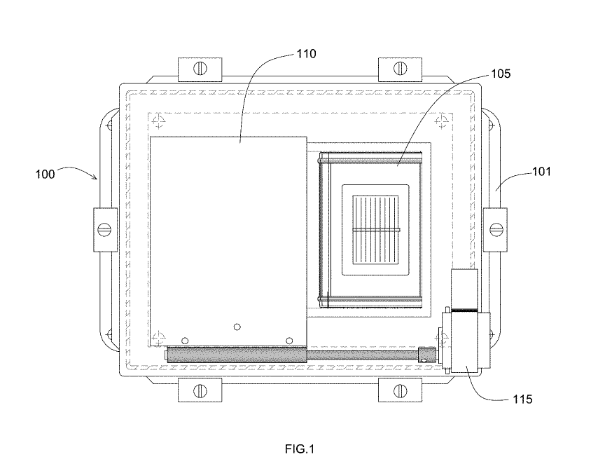

FIG. 1 shows a plan view of a soiling station 100 in accordance with an exemplary embodiment. The soiling station 100 may include an enclosure 101. The enclosure 101 may contain or support a first module or solar sensor 105, and a second module or sensor obscured in FIG. 1 by a cover 110. The cover 110 may be formed of any now known or later developed material suitable and configurable for protecting the second module from soiling factors such as weather exposure or impact exposure.

In an embodiment, the cover 110 may be rigid or deformable. The cover 110 may be slidable between a first position and a second position, and points therebetween. The cover 110 may be movable and configured as a door that protects the second module in a first position and exposes the second module when the cover 110 is moved to a second position. The cover 110 may be connected to and configured for operation by a motor system 115. The motor may be configured for automated or remote control of the cover 110. The motor system 115 may be configured and arranged to causing movement of the cover 110 to desired positions.

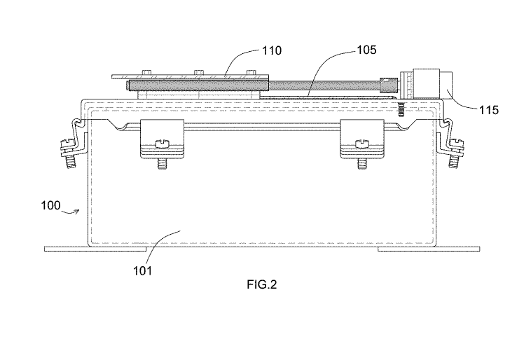

FIG. 2 shows a side view of a soiling station 100 in accordance with an exemplary embodiment. The soiling station 100 may include an enclosure 101 that supports or contains a first module 105, which may include a protective layer formed of, for example, glass, as shown. The soiling station 100 may include a cover 110. The cover 100 is shown in FIG. 2 in a position that covers and protects the first module. A motor system 115 may be configured for urging the cover 110 to desired positions, including a position away from the first module for exposing the first module to sunlight.

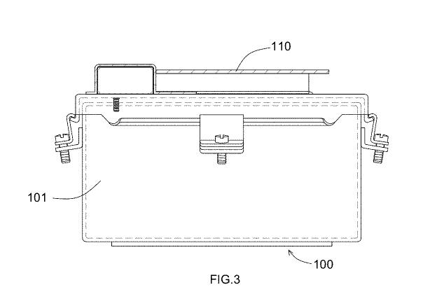

FIG. 3 shows a side view of a soiling station 100 in accordance with an exemplary embodiment. The soiling station 100 may include an enclosure 101 that supports or contains a first module. The soiling station 100 may include a cover 110. The cover 100 is shown in FIG. 2 in a position that covers and protects the first module. A motor system 115 may be configured for urging the cover 110 to desired positions, including a position away from the first module for exposing the first module to sunlight.

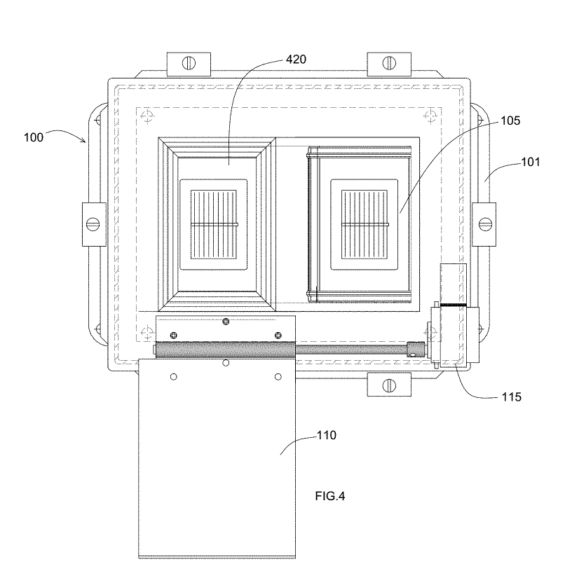

FIG. 4 shows a plan view of a soiling station 100 in accordance with an exemplary embodiment. The soiling station 100 may include an enclosure 101. The enclosure 101 may contain or support a first module 420 or solar sensor 105, and a second module or sensor obscured in FIG. 1 by a cover 110. The cover 110 may be formed of any now known or later developed material suitable and configurable for protecting the second module from soiling factors such as weather exposure or impact exposure. FIG. 4 shows the cover 110 disposed in a position away from the first module 420 in which the first module 420 is exposed to elements including sunlight and weather elements, for example.

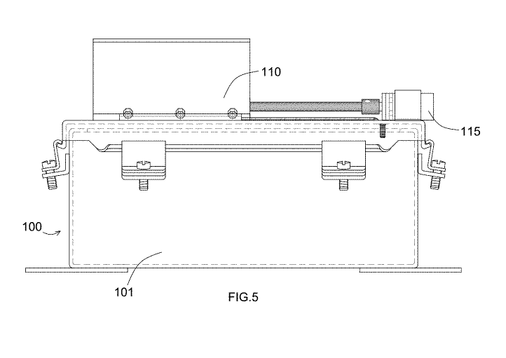

FIG. 5 shows a side view of a soiling station 100 in accordance with an exemplary embodiment. The soiling station 100 may include an enclosure 101 that supports or contains a first module 105, which may include a protective layer formed of, for example, glass, as shown. The soiling station 100 may include a cover 110. The cover 100 is shown in FIG. 2 in a position that exposes the first module, potentially rendering the first module vulnerable to soiling factors. A motor system 115 may be configured for urging the cover 110 to desired positions, including a position away from the first module for exposing the first module to sunlight, as shown in FIG. 5.

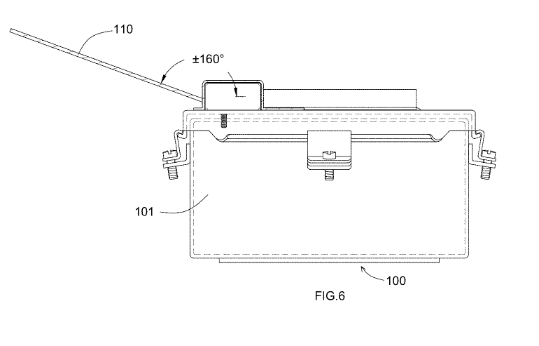

FIG. 6 shows a side view of a soiling station 100 in accordance with an exemplary embodiment. The soiling station 100 may include an enclosure 101 that supports or contains a first module. The soiling station 100 may include a cover 110. The cover 100 is shown in FIG. 2 in a position that covers and protects the first module. A motor system 115 may be configured for urging the cover 110 to desired positions, including a position away from the first module for exposing the first module to sunlight.

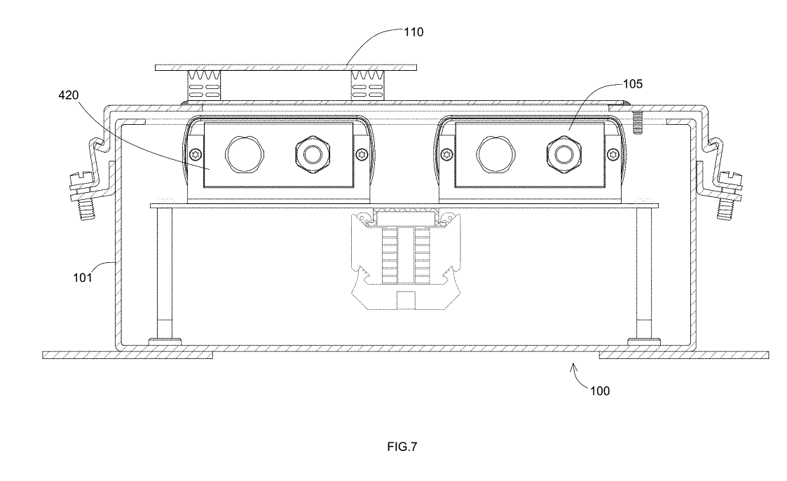

FIG. 7 shows a cross-sectional view of the apparatus of FIG. 1 along section A-A. In particular, FIG. 7 shows a soiling station 100 in accordance with an exemplary embodiment. The soiling station 100 may include an enclosure 101 that supports or contains a second module 420 and a first module 105. The soiling station 100 may include a cover 110. The cover 110 is shown in FIG. 7 in a position that covers and protects the first module 420.

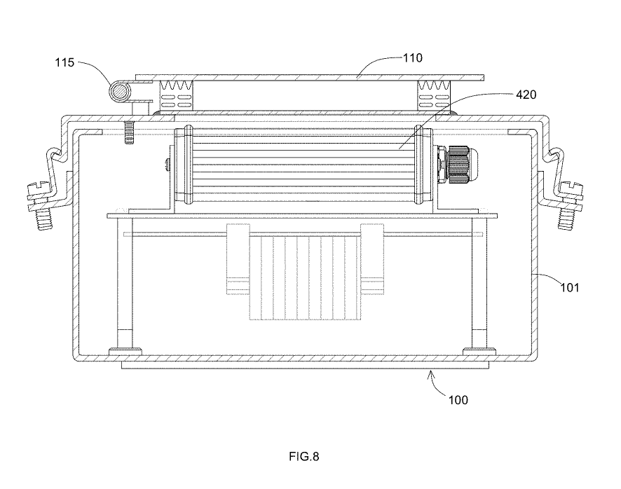

FIG. 8 shows a cross-sectional view of the apparatus of FIG. 1 along section B-B. In particular, FIG. 8 shows a soiling station 100 in accordance with an exemplary embodiment. The soiling station 100 may include an enclosure 101 that supports or contains a second module 420 and a first module 105. The soiling station 100 may include a cover 110. The cover 110 is shown in FIG. 7 in a position that covers and protects the second module 420.

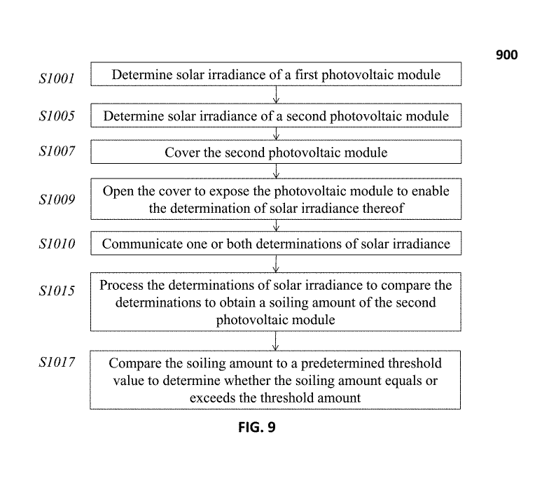

Methods may include determining solar irradiance of a first module or sensor, as shown in FIG. 9 at S1001 of a PV monitoring and maintenance process 900. Methods may include determining a temperature of a first portion, such as a bottom, of the first module, and determining a temperature of a second portion, such as a top, of the first module. Methods may include determining solar irradiance of a second module or sensor, or clean module, as shown at S1005 of FIG. 9. Methods may include determining a temperature of a first portion, such as a bottom, of the second module, and determining a temperature of a second portion, such as a top, of the second module. The first module is a soiled reference module that remains uncovered and exposed, while the second module is associated with a cover and configured to be covered and protected from the elements by the cover until removed to expose the underlying sensor to determine a solar irradiance thereof.

As shown in FIG. 9, methods may include covering, at S1007 the second module with a cover for protecting the second module from soiling factors. Methods may include opening the cover to expose the second module at S1009.

The measurements taken from the first and second modules may be stored, and may be processed, locally or remotely from the soiling station, and used to determine a soiling amount, such as a soiling percentage, of the first module. For example, either or both the determinations of solar irradiance may be communicated at S1010 to a remote apparatus for processing or for storage. Alternatively, the determinations may be stored or processed locally, or a combination of both. A position of the cover of the second module, and any error associated with the cover also may be determined and stored or communicated and for storage or processing. For example, a cleaning indicator may be triggered and presented to a user by any now known or later developed communications means based on the determined amount soiling.

As shown in FIG. 9, the determinations of solar irradiance may be compared at S1015 by processing the determinations and obtaining a soiling amount of the second module. The obtained soiling amount may be compared at S1017 to a predetermined threshold value to determine whether the soiling amount equals or exceeds the threshold amount.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. An apparatus, comprising:
a cover, the cover movable from a first position to a second position; and
a photovoltaic module, wherein the cover is configured and arranged to cover the photovoltaic module when the door is in the first position, and wherein a sensor is configured to detect a solar irradiance of the photovoltaic module.

2. The apparatus of claim 1, wherein the photovoltaic module is a first photovoltaic module, the apparatus comprising:
a second photovoltaic module, wherein the cover is configured to cover only the first photovoltaic module.

3. The apparatus of claim 2, wherein the sensor is a first sensor, the apparatus comprising:
a second sensor configured to detect a cover position of the cover.

4. The apparatus of claim 2, comprising:
an enclosure containing or supporting the first sensor, the second sensor, the first photovoltaic module, the second photovoltaic module, and the cover; and
a third sensor configured to detect a temperature of a first portion of the enclosure.

5. The apparatus of claim 4, comprising:
a fourth sensor configured to detect a temperature of a second portion of the enclosure.

6. The apparatus of claim 5, comprising:
a fifth sensor configured to detect solar irradiance, the fifth sensor configured and arranged to detect a solar irradiance of the second photovoltaic module.

7. The apparatus of claim 6, comprising:
one or more controllers for processing sensor data, the sensor data comprising data based on sensor feedback from at least one of the first sensor, the second sensor, the third sensor, the fourth sensor, and the fifth sensor.

8. The apparatus of claim 2, wherein a surface area of the first photovoltaic module is substantially equal to a surface area of the second photovoltaic module.

9. The apparatus of claim 2, wherein a surface area of the first photovoltaic module is less than a surface area of the second photovoltaic module.

10. The apparatus of claim 7, wherein the processing comprises comparing sensor data feedback from the first sensor with sensor data feedback from the second sensor for determining a soiling of the second photovoltaic module.

11. The apparatus of claim 1, comprising:
a motor configured to cause the cover to move between a first position and a second position.

12. The apparatus of claim 1, the cover further comprising:
a hinged door.

13. The apparatus of claim 1, wherein the cover is configured to form a sealed space surround the first photovoltaic module when the cover is disposed in the first position.

14. The apparatus of claim 1, comprising:
an enclosure supporting or containing the sensor, the photovoltaic module, and the cover, wherein the photovoltaic module interposes the enclosure and the cover when the cover is in the first position.

15. The apparatus of claim 1, wherein the cover is movable to a plurality of positions between and including the first position and the second position for providing variable coverage for protection of the first module that corresponds with varying levels of exposure to soiling.

16. The apparatus of claim 1, wherein the cover compromises a rigid material.

17. The apparatus of claim 1, wherein the cover comprises a deformable material.

18. A method, comprising:
determining solar irradiance of a first photovoltaic module;
determining solar irradiance of a second photovoltaic module;
communicating one or both determinations of solar irradiance;
processing the determinations of solar irradiance to compare the determinations to obtain a soiling amount of the second photovoltaic module; and
comparing the soiling amount to a predetermined threshold value to determine whether the soiling amount equals or exceeds the threshold amount.

19. The method of claim 18, comprising:
covering the second photovoltaic module; and
opening the cover to expose the photovoltaic module to enable the determination of solar irradiance thereof.

20. A system, comprising:
a first sensor configured for determining solar irradiance of a first photovoltaic module;
a second sensor configured for determining solar irradiance of a second photovoltaic module;
a communications system configured for communicating one or both determinations of solar irradiance; and
a processors configured for processing the determinations of solar irradiance to compare the determinations to obtain a soiling amount of the second photovoltaic module, and comparing the soiling amount to a predetermined threshold value to determine whether the soiling amount equals or exceeds the threshold amount.
